(19) United States
(12) Patent Application Publication
(10) Pub. No.: US 2017/0296005 A1
(43) Pub. Date: Oct. 19, 2017

(54) Seat Cover System

(71) Applicant: Glennis Reed, North Las Vegas, NV (US)

(72) Inventor: Glennis Reed, North Las Vegas, NV (US)

(21) Appl. No.: 15/098,435

(22) Filed: Apr. 14, 2016

(51) Int. Cl. A47K 13/16; F16M 13/02; B65D 83/08

(52) U.S. Cl. CPC A47K 13/165; B65D 83/0805; F16M 13/02

(57) ABSTRACT

A seat cover system includes a toilet that has a seat and a tank. The toilet may be positioned adjacent to a vertical support surface. A dispenser is coupled to the vertical support surface. The dispenser may contain a box of disposable seat covers thereby facilitating a selected disposable seat cover to be positioned around the seat. The dispenser includes a housing and a plate. The plate is coupled to the vertical support surface and the housing slidably engaging the plate such that housing is suspended on the plate.

### BACKGROUND OF THE DISCLOSURE

### Field of the Disclosure

The disclosure relates to seat cover devices and more particularly pertains to a new seat cover device for dispensing disposable seat covers for a toilet seat.

### SUMMARY OF THE DISCLOSURE

An embodiment of the disclosure meets the needs presented above by generally comprising a toilet that has a seat and a tank. The toilet may be positioned adjacent to a vertical support surface. A dispenser is coupled to the vertical support surface. The dispenser may contain a box of disposable seat covers thereby facilitating a selected disposable seat cover to be positioned around the seat. The dispenser includes a housing and a plate. The plate is coupled to the vertical support surface and the housing slidably engaging the plate such that housing is suspended on the plate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a seat cover system according to an embodiment of the disclosure.

FIG. 2 is a back view of an embodiment of the disclosure.

FIG. 3 is a back perspective view of an alternative embodiment of the disclosure.

FIG. 4 is a perspective view of an alternative embodiment of the disclosure.

FIG. 5 is a perspective in-use view of an embodiment of the disclosure.

FIG. 6 is a front view of an alternative embodiment of the disclosure.

FIG. 7 is a front perspective view of an alternative embodiment of the disclosure.

### DESCRIPTION OF THE PREFERRED EMBODIMENT

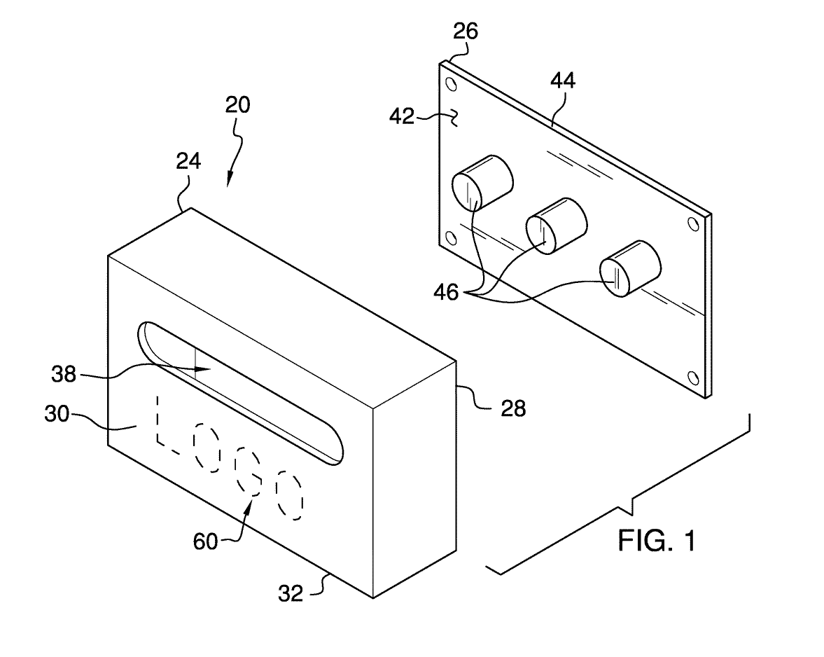

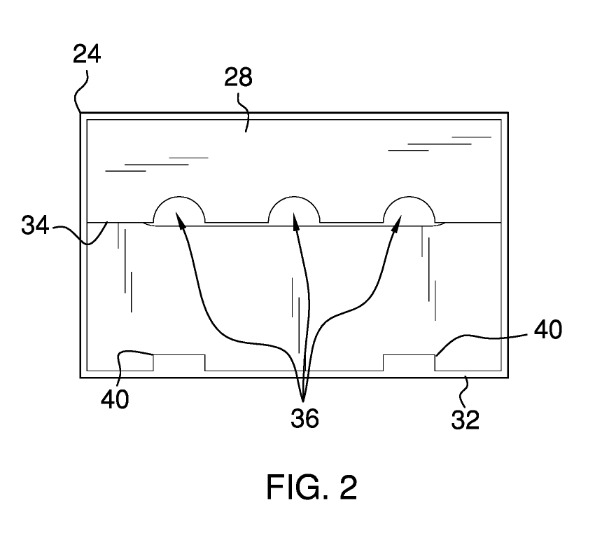

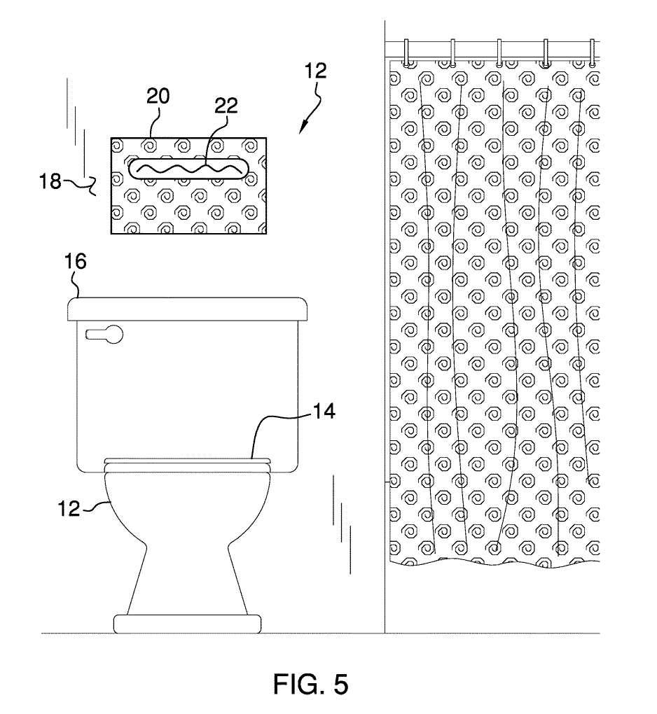

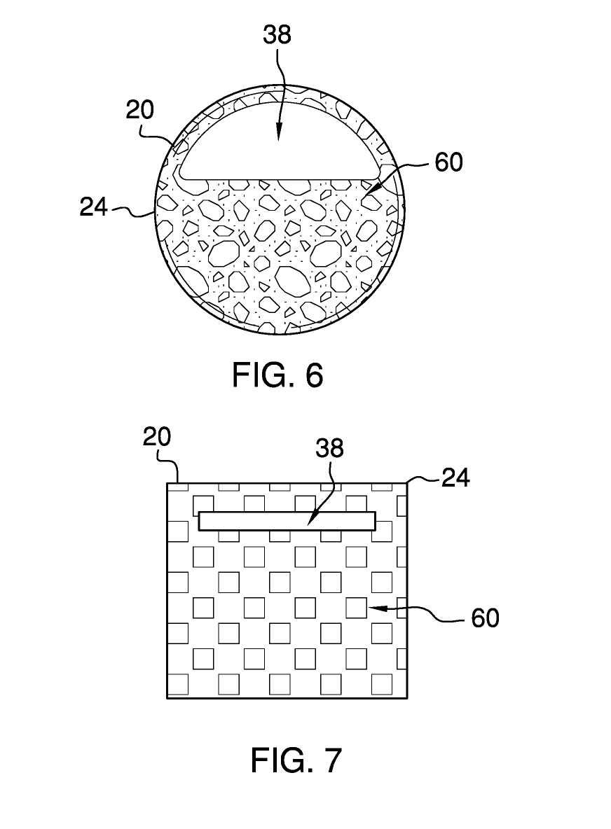

With reference now to the drawings, and in particular to FIGS. 1 through 7 thereof, a new seat cover device embodying the principles and concepts of an embodiment of the disclosure and generally designated by the reference numeral 10 will be described.

As best illustrated in FIGS. 1 through 7, the seat cover system 10 generally comprises a toilet 12 that has a seat 14 and a tank 16. The toilet 12 may be positioned adjacent to a vertical support surface 18. The vertical support surface 18 may comprise a wall or the like. A dispenser 20 is provided and the dispenser 20 may be coupled to the vertical support surface 18. The dispenser 20 may be spaced from the tank 16 and the dispenser 20 is accessible in conjunction with the toilet 12. The dispenser 20 may contain a box of disposable seat covers 22 thereby facilitating a selected disposable seat cover 22 to be positioned around the seat. The disposable seat covers 22 may comprise paper toilet seat covers or the like.

The dispenser 20 includes a housing 24 and a plate 26. The plate 26 is coupled to the vertical support surface 18. The housing 24 slidably engages the plate 26 such that housing 24 is suspended on the plate 26. The housing 24 has a back side 28, a front side 30 and a bottom side 32. The back side 28 is substantially open. The back side 28 has a lower edge 34 and the lower edge 34 is spaced from the bottom side 32.

The lower edge 34 has a plurality of grooves 36 extending upwardly therein. The grooves 36 are spaced apart from each other and distributed along the lower edge 34. The front side 30 has a slot 38 extending therethrough. The slot 38 may have the selected disposable seat cover 22 drawn outwardly therefrom.

The housing 24 includes a pair of tabs 40 and each of the tabs 40 extends upwardly from the bottoms side 32. Each of the tabs 40 is aligned with the lower edge 34 of the back side 28. Each of the tabs 40 abuts the box of disposable seat covers 22. Thus, each of the tabs 40 removably retains the box of disposable seat 22 covers in the housing 24.

The plate 26 has a front surface 42 and a rear surface 44. The rear surface 44 may be coupled to the vertical support surface 18. The plate 26 has a plurality of pegs 46 and each of the pegs 46 extends forwardly from the front surface 42. The pegs 46 are spaced apart from each other and distributed along the plate 26. The housing 24 is removably coupled to the plate 26 having each of the pegs 46 slidably engaging an associated one of the grooves 36. Thus, the housing 24 is suspended on the pegs 46.

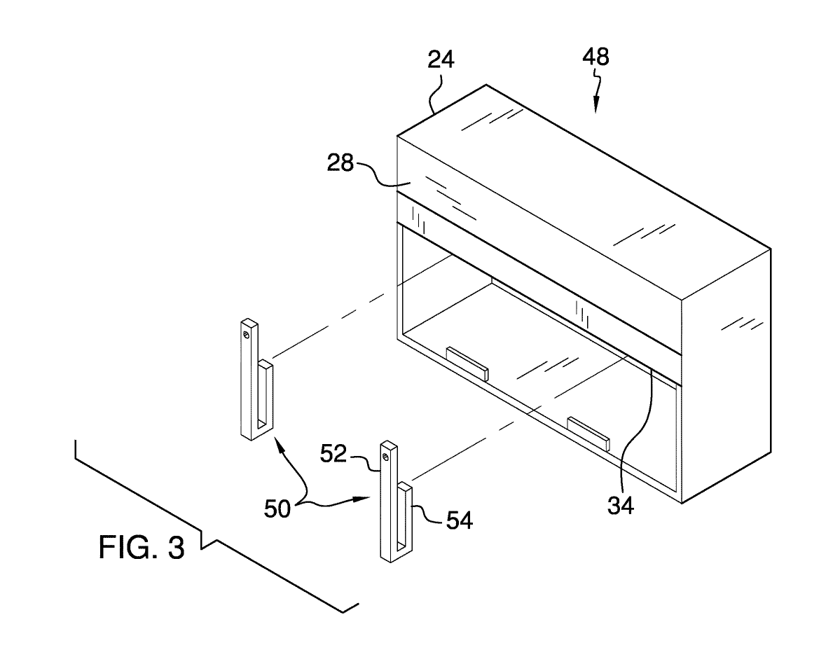

In an alternative embodiment 48 as shown in FIG. 3, a pair of clips 50 may be provided. Each of the clips 50 may include a leg 52 and a foot 54. The foot 54 corresponding to each of the clips 50 is spaced from the leg 52 of the corresponding clip 50. The leg 52 of each of the clips 50 may be coupled to the vertical support surface 18. The lower edge 34 corresponding to the back side 28 of the housing 24 is slid downwardly between the foot 54 and the leg 52 of each the clips 50. Thus, the housing 24 is retained on the vertical support surface 18.

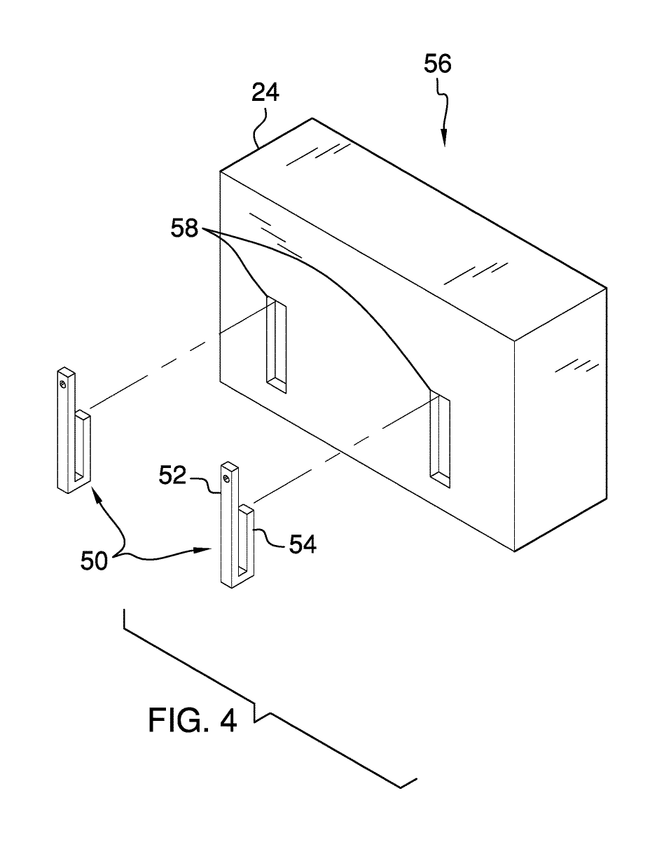

In an alternative embodiment 56 as shown in FIG. 4, the clips 50 are provided. The back side 28 of the housing 24 may extend downwardly to the bottom side 32 of the housing 24. The back side 28 may have a pair of wells 58 extending inwardly therein.

The foot 54 corresponding to each of the clips 50 may engage an associated one of the wells 58. Thus, the housing 24 is retained on the vertical support surface 18.

The front side 30 of the housing 24 may have indicia 60 printed thereon. The indicia 60 may comprise a logo, geometric shapes or other decorative patterns. The housing 24 may have a rectangular shape, a square shape or a round shape. The slot 38 may have an ovoid shape, a rectangular shape or a semi-circular shape.

The plate 26 has a plurality of holes 62 extending therethrough. The holes 62 are spaced apart from each other and distributed around the plate 26. A plurality of screws may be extended through an associated one of the holes 62 to engage the vertical support surface 18. Thus, the plate 26 is coupled to the vertical support surface 18.

In use, the plate 26 is coupled to the vertical support surface 18. The box of disposable seat covers 22 is positioned within the housing 24. The housing 24 is manipulated to slidably engage the pegs 46. Thus, the housing 24 is removably retained on the vertical support surface 18. The selected disposable seat cover 22 is grabbed and removed from the slot 38.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A seat cover system comprising:
a toilet having a seat and a tank, said toilet being configured to be positioned adjacent to a vertical support surface; and
a dispenser being configured to be coupled to said vertical support surface, said dispenser being spaced from said tank wherein said dispenser is configured to be accessible in conjunction with said toilet, said dispenser being configured to contain a box of disposable seat covers thereby facilitating a selected disposable seat cover to be positioned around said seat, said dispenser including a housing and a plate, said plate being configured to be coupled to the vertical support surface, said housing slidably engaging said plate such that housing is suspended on said plate said housing having a back side, a front side and a bottom side, said back side being substantially open, said back side having a lower edge, said lower edge being spaced from said bottom side, said lower edge having a plurality of grooves extending upwardly therein, said grooves being spaced apart from each other and distributed along said lower edge; and
a plurality of pegs coupled to and extending from said plate, each of said pegs having a smooth curved outer surface such that each said peg is cylindrical, said pegs being spaced apart from each other and distributed along said plate, said housing being removably coupled to said plate having each of said pegs slidably engaging an associated one of said grooves such that said housing is suspended on said pegs.

2. (canceled)

3. The system according to claim 1, wherein said front side has a slot extending therethrough wherein said slot is configured to have the selected disposable seat cover drawn outwardly therefrom, said housing including a pair of tabs, each of said tabs extending upwardly from said bottoms side, each of said tabs being aligned with said lower edge of said back side, each of said tabs being configured to abut the box of disposable seat covers thereby retaining the box of disposable seat covers in said housing.

4. The system according to claim 1, wherein
said plate has a front surface and a rear surface, said rear surface being configured to be coupled to the vertical support surface.

5. A seat cover system comprising:
a toilet having a seat and a tank, said toilet being configured to be positioned adjacent to a vertical support surface; and
a dispenser being configured to be coupled to said vertical support surface, said dispenser being spaced from said tank wherein said dispenser is configured to be accessible in conjunction with said toilet, said dispenser being configured to contain a box of disposable seat covers thereby facilitating a selected disposable seat cover to be positioned around said seat, said dispenser including a housing and a plate, said plate being configured to be coupled to the vertical support surface, said housing slidably engaging said plate such that housing is suspended on said plate, said housing having a back side, a front side and a bottom side, said back side being substantially open, said back side having a lower edge, said lower edge being spaced from said bottom side, said lower edge having a plurality of grooves extending upwardly therein, said grooves being spaced apart from each other and distributed along said lower edge, said front side having a slot extending therethrough wherein said slot is configured to have the selected disposable seat cover drawn outwardly therefrom, said housing including a pair of tabs, each of said tabs extending upwardly from said bottoms side, each of said tabs being aligned with said lower edge of said back side, each of said tabs being configured to abut the box of disposable seat covers thereby retaining the box of disposable seat covers in said housing, said plate having a front surface and a rear surface, said rear surface being configured to be coupled to the vertical support surface, said plate having a plurality of pegs, each of said pegs extending forwardly from said front surface, each of said pegs having a smooth curved outer surface such that each said peg is cylindrical, said pegs being spaced apart from each other and distributed along said plate, said housing being removably coupled to said plate having each of said pegs slidably engaging an associated one of said grooves such that said housing is suspended on said pegs.
